(19) United States
(12) Patent Application Publication
(10) Pub. No.: US 2007/0253637 A1
(43) Pub. Date: Nov. 1, 2007

(54) Image intensity calculation using a sectored source map

(75) Inventor: Konstantinos Adam, Belmont, CA (US)

Correspondence Address: Trellis Intellectual Property Law Group, PC, 1900 EMBARCADERO ROAD, SUITE 109, PALO ALTO, CA, 94303, US

(73) Assignee: Mentor Graphics Corp., Wilsonville, OR (US)

(21) Appl. No.: 11/715,825

(22) Filed: Mar. 8, 2007

Related U.S. Application Data
(60) Provisional application No. 60/780,191, filed on Mar. 8, 2006.

(51) Int. Cl. G06K 9/40

(52) U.S. Cl. 382/274

(57) ABSTRACT

A method for modeling an image of a mask under illumination by a source is provided. A source map of the source is determined. For example, the source map may be a k-space diagram of plane waves for the source. The source map is then segmented into a plurality of sectors. The plurality of sectors may be pre-defined or defined by a user. A partial image intensity is then calculated for each of the plurality of sectors using a Hopkins approach. The Hopkins approach may be calculated at a point in each of the sectors, such as the center of the sectors. Then, an image intensity for the source map is determined based on the partial image intensities determined for each of the plurality of sectors. For example, each of the partial image intensities is summed to determine a total image intensity for the source map.

### CROSS REFERENCES TO RELATED APPLICATIONS

This application claims priority from U.S. Provisional Patent Application Ser. No. 60/780,191 entitled HYBRID HOPKINS-ABBE SOCS METHOD WITH GEOMETRY-AWARE SOCS TRUNCATION, filed on Mar. 8, 2006, which is hereby incorporated by reference as if set forth in full in this application for all purposes.

### BACKGROUND

Particular embodiments generally relate to photolithographic processing and more particularly to calculating image intensity at a high numerical aperture.

In conventional semiconductor processing, circuit elements are created on a wafer by exposing photosensitive materials on the wafer with a pattern of transparent and opaque features on a mask or reticle. The selectively exposed areas of the photosensitive materials can then be further processed to create the circuit elements. As the size of the circuit elements to be created on the wafer becomes similar to, or smaller than, the wavelength of light or radiation that illuminates the mask, optical distortions can occur that adversely affect the performance of the circuit. To improve the resolution of the photolithographic process, many circuit design software programs use one or more resolution enhancement techniques (RETs) that attempt to compensate for the expected optical distortion such that the mask patterns will be printed correctly on the wafer.

It is well known that one factor in determining how well a pattern of features on a mask will print is the pattern of light or radiation that illuminates the mask. Certain types or orientations of features on a mask will print with better fidelity when exposed with a particular illumination pattern. For example, off-axis illumination is used because it increases resolution and depth of focus for certain layout patterns and design styles. The source shapes represent the distribution of angles of light falling on the mask. Some source maps may be simple geometric shapes, such as annular, quadrapole, dipole, etc., representing a simple distribution of angles of illumination. Others may be customized to be specific for the IC layout patterns being reproduced.

A RET may compute the image intensity for a given source to simulate the optical distortion of mask patterns. To compute the image intensity, several computational techniques are known, including the Hopkins approach and the Abbe approach. In the Hopkins approach, the properties of the source and the imaging lens are “lumped” together into a transmission-cross-coefficient (TCC), which can be pre-computed. These are then combined with a function representing the mask layout and integrated to compute the image intensity. The Hopkins approach relies on the assumption that constant scattering co-efficients are provided. The constant scattering co-efficients assume that a low numerical aperture (NA) is used to collect light diffracted from the mask. However, when off-axis illumination is used, the light being diffracted from the mask results in non-constant scattering co-efficients. Thus, the assumptions underlying the Hopkins approach break down. The Abbe approach may be used to accommodate the non-constant scattering co-efficients. However, the Abbe approach may not be suitable for use in a simulation of a full-chip capable optical proximity correction (OPC) or verification system. This is because, in the Abbe approach, image intensities for the mask from every source point in a source map are calculated first, and then summed to determine a total image intensity corresponding to the mask and the source map. Using the Abbe method involves performing computationally intensive calculations for each source point. The efficiency of Hopkins computational approach is thus lost when the assumption of having constant scattering co-efficients breaks down.

### SUMMARY

In one embodiment, a method for modeling an image of a mask under illumination by a source is provided. A source map of the source is determined. For example, the source map may be a k-space diagram of plane waves for the source. The source map is then segmented into a plurality of sectors. The plurality of sectors may be pre-defined or defined by a user. A partial image intensity is then calculated for each of the plurality of sectors using a Hopkins approach. Mask scattering coefficients may be calculated at a single point in each of the sectors, such as substantially the center of the sectors, and are assumed constant per the Hopkins approach for all illumination points within the sector. Then, an image intensity for the entire source is determined based on the partial image intensities determined for each of the plurality of sectors. For example, each of the partial image intensities is summed to determine a total image intensity for the source map.

In one embodiment, a method for determining an image intensity for a photomask layout to be used in a manufacturing process is provided. The method comprises: determining a source map of the illumination source; segmenting the source map into a plurality of sectors; calculating a partial image intensity value corresponding to the photomask layout for each of the plurality of sectors using a Hopkins approach within each sector; and determining a total image intensity corresponding to the photomask layout based on the partial image intensity value for each of the plurality of sectors.

In another embodiment, a computer readable medium comprising one or more instructions for execution by the one or more processors is provided. The one or more instructions are configured to determine an image intensity for a photomask layout to be used in a manufacturing process and when executed by the one or more processors operable to: determine a source map of the illumination source; segment the source map into a plurality of sectors; calculate a partial image intensity value corresponding to the photomask layout for each of the plurality of sectors using a Hopkins approach within each sector; and determine a total image intensity corresponding to the photomask layout based on the partial image intensity value for each of the plurality of sectors.

In yet another embodiment, a system configured to determine an image intensity for a photomask layout to be used source used in a manufacturing process is provided. The system comprises: an image intensity determiner configured to: determine a source map of the illumination source; segment the source map into a plurality of sectors; calculate a partial image intensity value corresponding to the photomask layout for each of the plurality of sectors using a Hopkins approach within each sector; and determine a total image intensity corresponding to the photomask layout based on the partial image intensity value for each of the plurality of sectors. Also, the system includes a simulator configured to simulate optical effects for an image of an object based on the image intensity determined.

A further understanding of the nature and the advantages of particular embodiments disclosed herein may be realized by reference to the remaining portions of the specification and the attached drawings.

### BRIEF DESCRIPTION OF THE DRAWINGS

FIG. 1 depicts a design verification and RET process according to one embodiment.

FIG. 2 is a schematic side view of a system for projection of a mask onto a target plane according to one embodiment.

FIG. 3 depicts a source map of plane waves that is used to determine image intensity according to one embodiment.

FIG. 4A shows an example of an illumination that does not use off-axis illumination.

FIG. 4B shows an example of off-axis illumination.

FIG. 5 depicts a simplified flowchart of a method for determining an image intensity according to one embodiment.

FIG. 6 depicts a simplified flowchart of a method for configuring the image intensity calculation according to one embodiment.

FIG. 7 shows a more detailed example of the simulator for modeling optical effects according to one embodiment.

### DETAILED DESCRIPTION OF EMBODIMENTS

To produce modern microdevices such as integrated circuits with photolithographic techniques, most photolithographic reticles or masks employ some sort of resolution enhancement technology (RET). Examples of RETs include optical and process correction (OPC, sometimes also called optical proximity correction) that may be used to determine distortions that may occur in a lithographic processing to improve the ability of the system to print a desired pattern of objects on a semiconductor wafer. Although photolithography is described, it will be understood that particular embodiments may be used in other processes, such as phase-shifting masks (PSM), chemical mechanical processing (CMP), etch, etc.

To apply these RETs, the effect of these distortions on the actual geometric structures of a microdevice is simulated. The impact of the distortions may be determined and features in a layout may be changed to account for the distortions that may occur.

Particular embodiments include a prediction of the image intensity at the imaging plane for a given source distribution. The image intensity result may be used to perform OPC or RET techniques. A source map may be segmented into a plurality of sectors. Then, a Hopkins computational approach may be used to determine a partial image intensity for each sector. The partial image intensities are then used to determine a total image intensity corresponding to the source map. The total image intensity may then be used in a model to perform OPC or RET for a layout of a microdevice to simulate the optical effects.

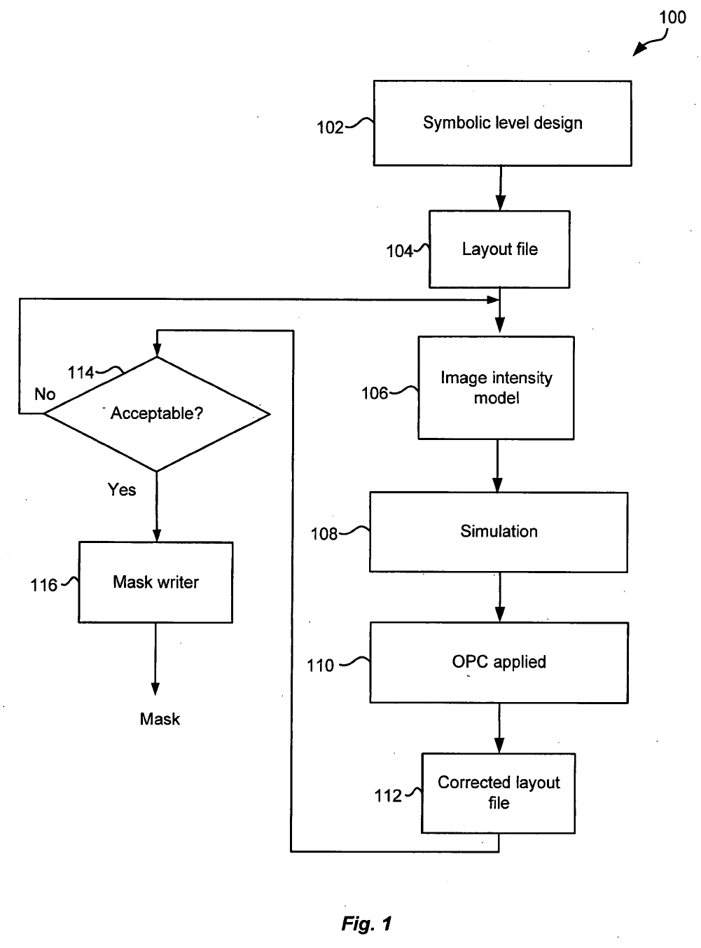

FIG. 1 depicts a design verification and RET process according to one embodiment. The process includes determining a symbolic level design 102. Symbolic level design 102 may be a register transfer logic (RTL) representation of an IC design. A data layout file 104 or portion thereof, is determined that defines a desired pattern of objects to be created on a wafer. This is typically a layer of a device layout in a standard format such as graphical design system (GDS)-II or OASIS, although other formats can also be used. The data in these layers will be used to define the shape of the openings in the photolithographic reticle or mask that will be used in a photolithography system.

A simulation 108 of an image intensity of the projected light from a photomask fabricated from data in layout file 104 at any given point on the wafer is carried out using an image intensity model 106. From the results of the simulated image intensity, OPC or other RETs 110 are applied to the layout data to compensate for the predicted distortions and improve the resolution and pattern fidelity of the printed objects. A corrected layout file 112, including the results of the applied RETs, may be determined. It is then determined if corrected layout file 112 is acceptable for use in generating a mask. If not, the process may reiterate to perform the simulation again with data in corrected layout file 112.

If corrected layout file 112 is acceptable, it is provided to a mask writer 116 that produces a number of photomasks or reticles (hereinafter commonly referred to as a mask) used in the lithographic system to produce the desired devices on wafers.

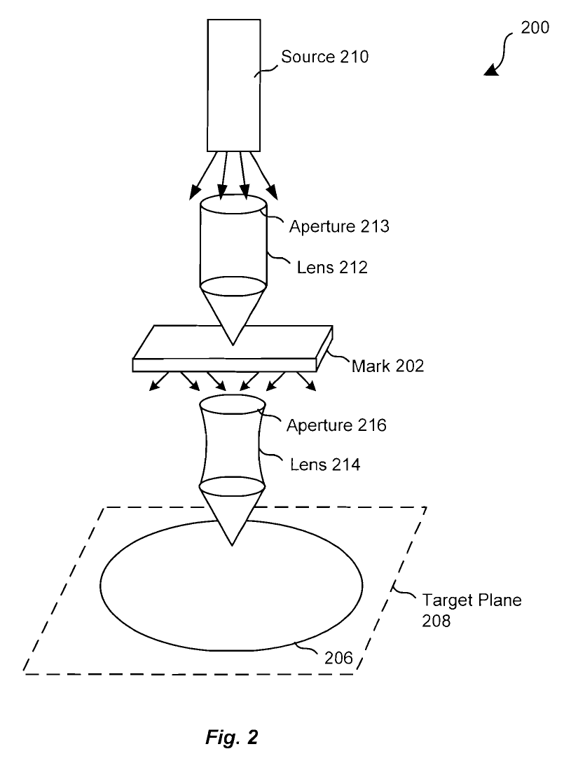

FIG. 2 is a schematic side view of a system 200 for projection of a mask 202 onto a target plane 208 according to one embodiment. Typically, mask 202 embodies a predetermined design for a thin film layer that is to be formed by photolithography on a substrate 206 at plane 208, as is known in the art.

An illumination source 210 emits radiation, which typically comprises visible, ultraviolet or infrared radiation. In one embodiment, source 210 may be an examer laser. A condenser lens 212, having an aperture 213, focuses the light from source 210 through mask 202. Mask 202 may be a structure that includes a pattern for a circuit layout of an integrated circuit. The pattern is illuminated which causes diffraction in the light. The light then shines through a projection lens 214 having an aperture 216, which focuses an aerial image of mask 202 onto plane 208. Typically, lenses 212 and 214 comprise complex, multi-element lenses. The respective apertures 213 and 216 and respective distances of lenses 212 and 214 from mask 202 define respective numerical apertures.

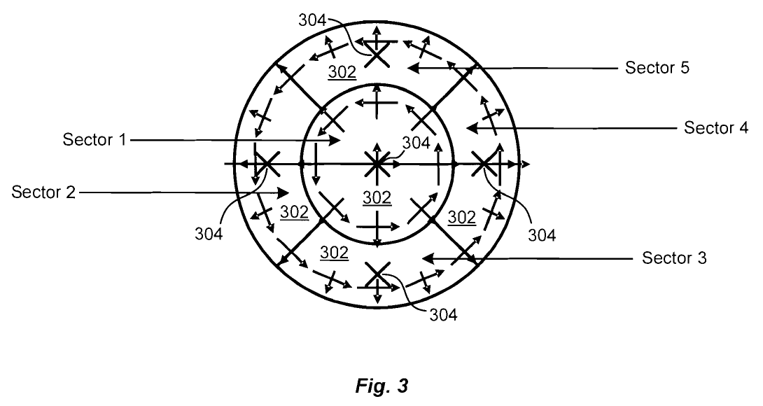

The optical effects of objects printed on substrate 206 in system 200 may be simulated. An image intensity is used to perform the simulation. FIG. 3 depicts a source map 300 of plane waves that is used to determine image intensity according to one embodiment. The source map may be a k-space diagram of plane waves based on a simulation of an image focused onto plane 208. Source map 300 may be used to determine an image intensity of an image of mask 202.

The Hopkins approach is known in the art and is used to determine an image intensity at the wafer level. That is, the image intensity of light that results after being focused by lens 214. In the Hopkins approach, the properties of the source and the imaging lens are “lumped” together into a transmission-cross-coefficient (TCC), which can be pre-computed. These are then combined with a function representing the mask layout and integrated to compute the image intensity. Hopkins is based on the assumption that constant scattering co-efficients result from source illumination. However, off-axis illumination may be used because it increases resolution and depth of focus for certain layout patterns and design styles. Different sources may be used for off-axis illumination, such as annular, quadrupole, dipole, etc. The scattering coefficients are calculated from a point in source map 300. They are assumed constant for the entire source sector. Off-axis illumination may cause the Hopkins approach to break down when calculated for a point in source map 300 if non-constant coefficients result. For example, if the center of source map 300 is used to calculate the image intensity, the Hopkins approach may not work at some angles of off-axis illumination because the scattering coefficients are not constant.

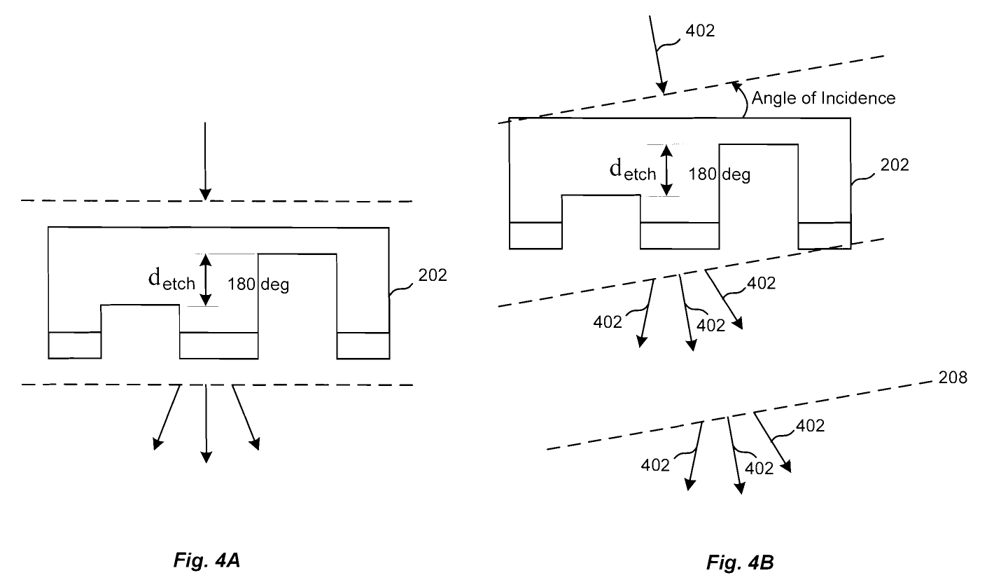

FIG. 4A shows an example of an illumination that does not use off-axis illumination. This assumes that there are constant scattering co-efficients for each angle of illumination that differ only by a phase factor e^{jφx}. That is, the source falls on a mask 202 without a large angle of incidence with respect to an object plane of mask 202.

However, off-axis illumination is being used to increase resolution and depth of. focus for layout patterns. FIG. 4B shows an example of off-axis illumination. As shown, light rays 402 are shown at a large angle of incidence to an object plane of mask 202. This results in non-constant scattering coefficients for the diffracted light that depend on the incidence angle. The numerical aperture (NA) is the sine of the angle of incidence at the pupil. The assumption that the diffracted orders can be represented by their normal incidence versions multiplied by a phase factor e^{jφx}, where x is the position, to account for the angle of incidence breaks down as NA increases. For example, as NA becomes greater than 1.2 and the angle of incidence, θ_{0,max}, becomes substantially around 17.5 degrees, the Hopkins approach may not accurately model the image intensity. As discussed above, the Abbe method may be used to accommodate non-constant scattering coefficients that depend on the incidence angle. However, the Abbe method may not be suitable for use in a simulation engine of a full chip capable optical proximity correction or verification system because it is computationally inefficient. This is because the Abbe method performs the image intensity calculation at every source point. This is computationally intensive and also time-consuming.

To balance accuracy and speed, particular embodiments segment source map 300 into a plurality of sectors 302. The plurality of sectors 302 may be determined in any way. For example, a user may define how many sectors are desired or the number of sectors may be pre-set based on the source used. As shown in FIG. 3, five sectors 302 have been determined. However, it will be understood that any number of sectors 302 may be determined as long as two or more sectors are determined.

In each sector 302, the Hopkins approach is applied. Because source map 300 is broken up into a plurality of smaller sectors 302 (as opposed to using the entire source map 300), the angular extent of each sector 302 may be decreased. For example, when taken as a smaller section of source map 300, the distribution of the angle of incidence for the off-axis illumination over the sector may be reduced, thus resulting in near-constant scattering co-efficients. Accordingly, the assumption of constant scattering coefficients over the sector may become valid again. Thus, the Hopkins approach can be used for each of the sectors 302.

A point 304 is determined inside each sector 302. For example, a point substantially in the center of a sector 302 is determined. Although the center is described, it will be understood that other points may be determined. The scattering coefficients are then calculated using the point in each sector 302 and the Hopkins approach is used for the sector. The result of each calculation provides a partial image intensity for sections 302. The calculation for determining the partial image intensity is described in more detail below.

Once the partial image intensity is determined for each sector 302, the total image intensity may be determined for source map 300. In one embodiment, the sum of all the partial image intensities is determined.

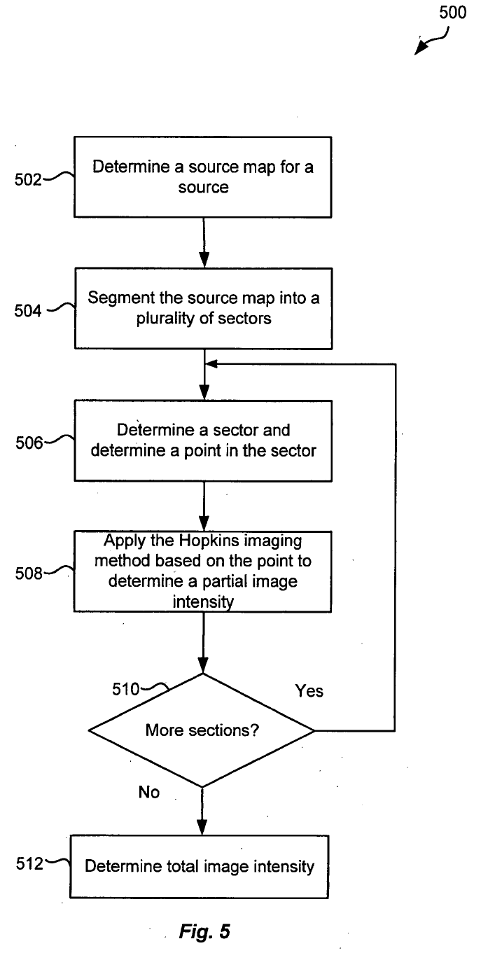

FIG. 5 depicts a simplified flowchart 500 of a method for determining an image intensity according to one embodiment. Step 502 determines a source map 300 for a source. Step 504 segments the source map 300 into a plurality of sectors 302. Different optical sources 210 may require different numbers of sectors. For example, for a quadrapole source, the source map may be segmented into four sectors and for a dipole source, the source map may be segmented into two sectors, and for an annular source, the source map may be broken into four sectors. Other sector patterns may also be used.

Then, the Hopkins approach may be performed for each of the sectors 302. Step 506 determines a sector 302 and determines a point 304 in the sector 302. Within each sector 302, the scattering coefficients may be approximately constant and can be calculated using the single point 304 in sector 302. The scattering coefficients may be determined based on objects in mask 202 and point 304 in each sector 302. To determine if the scattering co-efficients are constant, discrete mask (object) edges that are present in a particular mask are pre-simulated to compute the near field scattering of each mask edge. Incidence angles that are dictated by the previously described division of total illumination source into sectors are used to compute the scattering coefficients. The single point 304 corresponds to one incidence angle within each sector 302. The center of gravity of each sector 302, i.e., a point in the center of sector 302 may be suitable choice, but other points within the sector can be equally suitable. Each incidence angle can correspond to the center of each respective sector 302. A final synthesis of object scattering coefficients for each sector 302 is calculated by appropriately combining the terms from the isolated edges. The scattering coefficients are assumed constant within the sector and the Hopkins approach can be used

Step 508 applies the Hopkins approach based on point 304 to determine a partial image intensity. In one embodiment, the following Hopkins integral shown in equation (1) may be used in the Hopkins approach:

$$i ( x , y ) = \int \int {\int }_{- ∞}^{∞} \int [ \int {\int }_{- ∞}^{∞} {\overline{J}}_{o} ( f , g ) \overline{K} ( f + {f}^{′} , g + {g}^{′} ) {\overline{K}}^{*} ( f + {f}^{′′} , g + {g}^{′′} ) ⅆ f ⅆ g ] \cdot \cdot {\overline{T}}_{o} ( {f}^{′} , {g}^{′} ) {\overline{T}}_{o}^{*} ( {f}^{′′} , {g}^{′′} ) {ⅇ}^{- j 2 π [ ( {f}^{′} - {f}^{′′} ) x + ( {g}^{′} - {g}^{″} ) y ]} ⅆ {f}^{′} ⅆ {g}^{′} ⅆ {f}^{″} ⅆ {g}^{″} \qquad ( 1 )$$

A person skilled in the art would appreciate how to use the Hopkins integral to determine an image intensity. Briefly, the Hopkins integral includes a transmission cross co-efficient (TCC) and a mask transmission function. The TCC is dependent on the optical system used. The mask transmission function is determined based on information for the mask used. When mask is referred to, it will be understood that mask may also be referred interchangeably with a layout, object, etc. The object may be a mask, object represented in the mask, or object in the layout.

Equation (1) can be decomposed into a set of coherent systems (SOCS). A series of kernels for the sum of coherent systems (SOCS) can be determined that represents the TCC function. The SOCS kernel series can be convolved with the mask transmission function as shown in equation (2).

$$i ( x , y ) ≅ {\sum }_{k = 1}^{N} {σ}_{k} {\vert {h}_{k} ( x , y ) ⊗ {T}_{o} ( x , y ) \vert}^{2} \qquad ( 2 )$$

The SOCS method yields the final image intensity. The SOCS method is now applied separately for each source sector 302. The Hopkins integral is calculated for each sector 302, may be a more efficient calculation of image intensity than using the Abbe approach, which calculates image intensity using every source point 304.

The Abbe approach requires calculation of partial image intensities at every source point 304 and is therefore typically less efficient than the Hopkins approach. The Abbe integral for image calculation is as follows:

$$\begin{matrix}i ( x , y ) = \int {\int }_{- ∞}^{∞} ⅆ α ⅆ β {I}_{s} ( α , β ) \int \int {\int }_{- ∞}^{∞} \int ⅆ {x}_{1} ⅆ {y}_{1} ⅆ {x}_{2} ⅆ {y}_{2} K ( x , y ; {x}_{1} , {y}_{1} ) \\ {K}^{*} ( x , y ; {x}_{2} , {y}_{2} ) \cdot \cdot F ( {x}_{1} , {y}_{1} ; α , β ) {F}^{*} ( {x}_{2} , {y}_{2} ; α , β ) \\ {T}_{o} ( {x}_{1} , {y}_{1} ) {T}_{o}^{*} ( {x}_{2} , {y}_{2} )\end{matrix}$$

Using the Abbe approach, an image intensity is determined at each source point 304 and the image intensities are summed. Re-computing the scattering coefficients at every source point 304, although possible, is computationally intensive and thus does not make the Abbe integral ideal for full-chip simulation. Because the Hopkins imaging integral is applied at different sectors, the TCC function is different for each sector 302. However, the TCC can be computed once for each section 302. Computing the TCC for each of sectors 302 is less than the number of source points 304 thus making the image intensity calculation more efficient. For example, using source map 300, only 5 TCCs need to be calculated to determine the image intensity of source map 300.

Accordingly, particular embodiments use the Hopkins approach for each sector 302. The angle of incidence may be different for each sector 302 and thus a different TCC is calculated for each sector. The image intensity for one of the sectors 302 is then determined in step 508

Once the partial image intensity is determined, step 510 determines if the partial image intensity for other sectors 302 needs to be determined. If so, the process reiterates to step 306 where another partial intensity for another sector 302 is determined.

If the partial image intensity has been determined for each sector 302, then step 512 determines the total image intensity for source map 300. For example, the partial image intensities for each sector 302 may be summed.

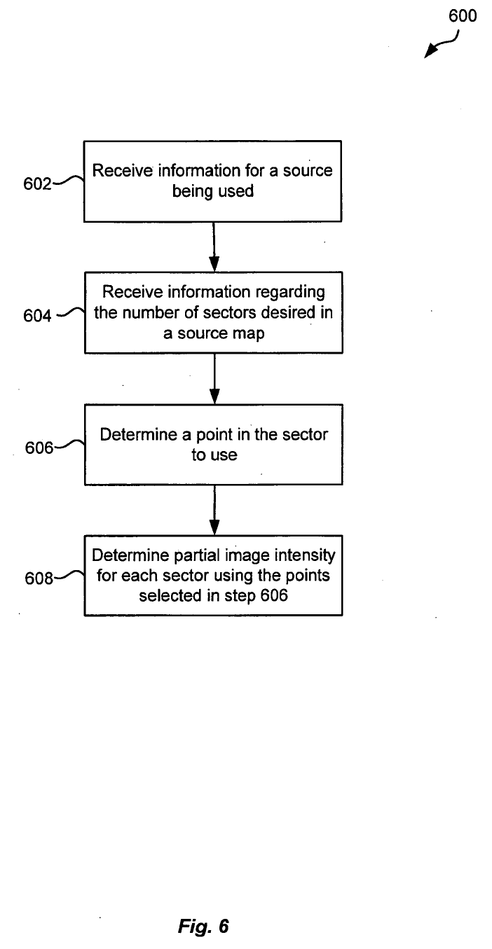

The user may configure parameters to determine the image intensity in particular embodiments. For example, FIG. 6 depicts a simplified flowchart 600 of a method for configuring the image intensity calculation according to one embodiment. Step 602 receives information for a source 210 being used. For example, the source 210 being used may be dipole, quadrupole, annular, etc.

Step 604 receives information regarding the number of sectors 302 desired in a source map 300. For example, a user may specify how many sectors 302 are desired. Also, depending on the source used, the number of sectors 302 may be automatically determined.

Step 606 determines a point in sector 302 to use. For example, a user may specify a desired point in each sector 302 that may be used as a source point 304 for calculating mask scattering coefficients. In one embodiment, suggestions may be determined automatically and outputted to a user for selection. Also, the user may select a point, such as by using a graphical user interface to determine the point to use in each sector 302.

In step 608, the partial image intensity is determined for each sector 302 using the points selected in step 606. For example, the TCCs may be pre-determined for each sector 302. Then, a SOCS calculation is then used to determine the partial image intensity.

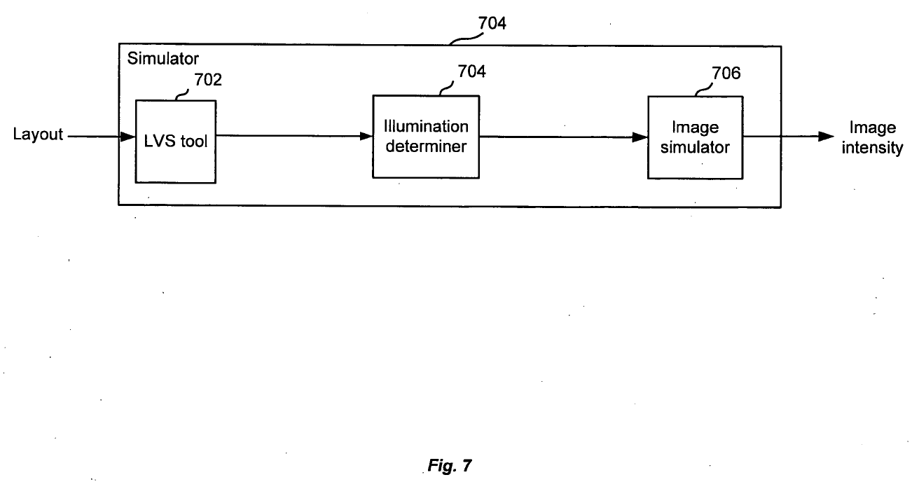

FIG. 7 shows a more detailed example of the simulator process for modeling optical effects according to one embodiment. A layout is provided to a layout versus schematic (LVS) tool 702. LVS tool 702 may verify the layout versus schematic. For example, the wires and layers may be checked to see that they connect correctly. Also, a design rule check may be performed to make sure the layout versus schematic follows the rules.

An illumination determiner 704 is configured to determine an image intensity. For example, a model is determined that models the image intensity of a source after it is diffracted through a mask into a lens and focused onto a wafer. The image intensity is determined as described above.

An image simulator 706 then simulates the image of an object in a layout as it would be if it were created on a wafer by a photolithographic process. For example, the image intensity is used in a model to simulate how an object in the mask is created on the wafer. The process then reiterates to a layout step in which the layout may be adjusted based on the simulated image on the wafer. The process may then continue until an acceptable layout is determined.

Although the description has been described with respect to particular embodiments thereof, these particular embodiments are merely illustrative, and not restrictive. Although particular embodiments are described with respect to the creation of integrated circuits, it will be appreciated that the techniques of particular embodiments may be applied to any manufacturing process that is subject to process variations. Examples of processes include, but are not limited to, mask bias, overlay errors, film stack thickness variations, mask phase errors, post-exposure bake temperatures, resist development times and post exposure bake times. Other devices fabricated lithographically where particular embodiments may be applied may include Micro-electromechanical systems (MEMS), magnetic heads for disk drives, photonic devices, diffractive optical elements, nanochannels for transporting biological molecules, etc.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for determining an image intensity for a photomask layout to be used in a manufacturing process, the method comprising:
determining a source map of the illumination source;
segmenting the source map into a plurality of sectors;
calculating a partial image intensity value corresponding to the photomask layout for each of the plurality of sectors using a Hopkins approach within each sector; and
determining a total image intensity corresponding to the photomask layout based on the partial image intensity value for each of the plurality of sectors.

2. The method of claim 1, wherein determining the total image intensity comprises summing the partial image intensity values for the plurality of sectors.

3. The method of claim 1, wherein scattering coefficients used in the Hopkins approach calculation are computed at a single point for at least one sector.

4. The method of claim 3, wherein the single point for at least one sector is a point substantially in a center of the sector.

5. The method of claim 3, wherein the scattering coefficients used in the Hopkins approach calculation are computed at a single point for each sector.

6. The method of claim 5, wherein the single point for at least one sector is a point substantially in a center of each sector.

7. The method of claim 1, further comprising:
determining one or more transmission cross coefficients (TCCs) for each of the plurality of sectors; and
determining the partial image intensity value for a sector in the plurality of sectors using the one or more TCCs for the sector.

8. The method of claim 1, wherein the partial image intensity value is determined using a sum of coherent systems (SOCS) to compute the TCCs and a mask transmission function to represent the photomask being used in the manufacturing process.

9. The method of claim 1, wherein the source map has a distribution corresponding to off-axis illumination of the mask by the source.

10. The method of claim 1, wherein the source map is designed to have a distribution considering the particular features for the photomask layout.

11. The method of claim 1, further comprising using the total image intensity to simulate an image of the mask that will be created on a wafer based on an illumination of the source.

12. A computer readable medium comprising one or more instructions for execution by the one or more processors, the one or more instructions configured to determine an image intensity for a photomask layout to be used in a manufacturing process and when executed by the one or more processors operable to:
determine a source map of the illumination source;
segment the source map into a plurality of sectors;
calculate a partial image intensity value corresponding to the photomask layout for each of the plurality of sectors using a Hopkins approach within each sector; and
determine a total image intensity corresponding to the photomask layout based on the partial image intensity value for each of the plurality of sectors.

13. The computer readable medium of claim 12, wherein the one or more instructions when executed are further operable to sum the partial image intensity values for the plurality of sectors.

14. The computer readable medium of claim 12, wherein scattering coefficients used in the Hopkins approach calculation are computed at a single point for at least one sector.

15. The method of claim 14, wherein the single point for at least one sector is a point substantially in a center of the sector.

16. The method of claim 14, wherein the scattering coefficients used in the Hopkins approach calculation are computed at a single point for each sector.

17. The method of claim 16, wherein the single point for at least one sector is a point substantially in a center of each sector.

18. The computer readable medium of claim 12, wherein the one or more instructions when executed are further operable to:
determine one or more transmission cross coefficients (TCCs) for each of the plurality of sectors; and
determine the partial image intensity value for a sector in the plurality of sectors using the one or more TCCs for the sector.

19. The computer readable medium of claim 12, wherein the partial image intensity value is determined using a sum of coherent systems (SOCS) to compute the TCCs and a mask transmission function to represent the photomask being used in the manufacturing process.

20. The computer readable medium of claim 12, wherein the source map has a distribution corresponding to an off-axis illumination of the mask by the source.

21. The computer readable medium of claim 12, wherein the source map is designed to have a distribution considering the particular features for the photomask layout.

22. The computer readable medium of claim 9, wherein the one or more instructions when executed are further operable to use the total image intensity to simulate an image of the mask that will be created on a wafer based on an illumination of the source.

23. A system configured to determine an image intensity for a photomask layout to be used source used in a manufacturing process, the system comprising:
an image intensity determiner configured to:
determine a source map of the illumination source;
segment the source map into a plurality of sectors;
calculate a partial image intensity value corresponding to the photomask layout for each of the plurality of sectors using a Hopkins approach within each sector; and
determine a total image intensity corresponding to the photomask layout based on the partial image intensity value for each of the plurality of sectors.

24. The system of claim 23, further comprising a simulator configured to simulate optical effects for an image of an object based on the image intensity determined.

25. The system of claim 23, wherein the object comprises an object in a layout of an integrated circuit.

26. The system of claim 23, wherein the simulator receives a layout file of a layout of an integrated circuit and used the layout file to model optical effects for the object in the file.

27. The system of claim 26, wherein a corrected layout file is determined using the simulation.
